(19) United States
(12) Patent Application Publication
(10) Pub. No.: US 2008/0253617 A1
(43) Pub. Date: Oct. 16, 2008

(54) Method and Apparatus for Determining the Shot Type of an Image

(75) Inventors: Fabian Edgar Ernst, Hoofddorp (NL); Johannes Weda, Eindhoven (NL); Mauro Barbieri, Eindhoven (NL); Stijn De Waele, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,993

(22) PCT Filed: Sep. 11, 2006
(86) PCT No.: PCT/IB2006/053211

§ 371 Date: Mar. 25, 2008

(30) Foreign Application Priority Data
Sep. 29, 2005 (EP) 05109019.9

(51) Int. Cl. G06T 5/00

(52) U.S. Cl. 382/106

(57) ABSTRACT

A method and apparatus for determining the type of shot of an image is disclosed. The method comprising the steps of: assigning (203, 205) portions of the image to at least a first cluster or a second cluster, the clusters having different ranges of depth values associated therewith; and determining (207, 209) the shot type of the image on the basis of whether both the first and second clusters have been assigned at least one portion or whether there is a stepped or gradual change in the difference between the depth of the first and second clusters.

### FIELD OF THE INVENTION

The present invention relates to method and apparatus for determining the shot type of an image.

### BACKGROUND OF THE INVENTION

Video content is built up from different kind of shot types, which are intended by the director to bring across different kinds of information. Typically, these shots are classified into three types, namely a long shot, a medium shot and a close-up shot or short shot. A long shot shows an entire area of action including the place, the people, and the objects in their entirety. In a medium shot the subject and its setting occupies roughly equal areas in the frame. A close-up shot or short shot shows a small part of a scene, such as a character's face, in detail, so it fills the scene. FIG. 1a shows an example of a long shot and FIG. 1b shows an example of a medium shot.

Automatic classification of shots (or even individual frames) into long shots, medium shots and close-ups provides useful information for video content analysis applications like scene chaptering. It also proves useful in several video signal processing approaches, for example rendering on 3D screens, where a long shot may be rendered differently from a close-up, for instance by rendering the foreground in a close-up close to the screen plane in order to have it as sharp as possible, whereas for a long shot larger fractions of the scene may be rendered in front of the screen.

For automatic classification, a feature which is computable from the frame or shot is required. This feature needs to be able to distinguish between long shots and medium shots and close-ups. One known technique uses several types of information for determining the shot type. This includes motion, focus, texture, camera motion, field of view and many others. However, this technique is complex and can be inaccurate in distinguishing between the types of shots.

### SUMMARY OF THE INVENTION

It is desirable to provide automatic classification of shots which is computationally simple with improved accuracy.

This is achieved according to an aspect of the present invention, by providing a method for determining the type of shot of an image, the method comprising the step of: assigning portions of the image to at least a first cluster or a second cluster, the clusters having different ranges of depth values associated therewith; determining the shot type of the image on the basis of whether both said first and second clusters have been assigned at least one portion or whether there is a stepped or gradual change in the difference between the depth of said first and second clusters.

This is also achieved according to a further aspect of the present invention, by providing apparatus for determining the type of shot of an image, the apparatus comprising: interface means for input of an image; and a processor for assigning portions of the image to at least a first cluster or a second cluster, the clusters having different ranges of depth values associated therewith and for determining the shot type of the image on the basis of whether both said first and second clusters have been assigned at least one portion or whether there is a stepped or gradual change in the difference between the depth of said first and second clusters.

The basic concept is that if at least two clusters of depth values can be distinguished, i.e. there is a marked or stepped difference in the depth, the video frame is a close-up or medium shot type, whereas if no such distinction in the cluster is present, a gradual profile, or there is only one cluster, this indicates a long shot. In a preferred embodiment, as the depth signal has a very direct relation to the scene, it can directly be used, simply, as a scene classifier.

Preferably, the decision of whether there is a marked or stepped difference in depth values is based on statistical properties of said clusters. These may include at least one of a difference in the means of said depth values between said first and second clusters, a standard deviation of depth values in a cluster and the area of a cluster.

These provide a simple computational method which is fast, effective and accurate.

The step of determining whether there is a stepped or gradual change in the difference between the depth of the first and second clusters may comprise the steps of: comparing the standard deviation of the depth values in one of the first and second clusters with the difference in the mean depth values between the first and second clusters; and if the standard deviation is relatively small compared to the difference in the mean depth values, there is a stepped change in the difference between the depth of the first and second clusters and the image is classified as a short shot type.

The medium or short shot type, or close-up, is then easily identified by a simple test of the statistical properties of the clusters.

The step of determining whether there is a gradual change in difference between the depth of the first and second clusters may comprise the steps of: comparing the difference in the mean depth values between the first and second clusters; determining if the difference between the mean depth values is less than a threshold value; and if the difference between the mean depth values is less than the threshold value, there is a gradual change in the difference between the depth of the first and second clusters and it is determined that the image is a long shot.

Further, the method may comprise the step of: comparing the areas of each of the first and second clusters; and if one of the first and second clusters is small, or zero, or if the difference in area is greater than a threshold value, the image is determined as a long shot type.

The first and second clusters may comprise the background and the foreground of the image.

Portions of the image which are on the border between the first and second clusters may be identified and the difference of the depth of the pixels to the identified portion of the mean depth value of each of the first and second clusters may be computed; and the portion may then be assigned to the cluster to which it has the smallest depth difference.

In this way, portions which are on the boundary can be assigned more accurately.

If the image is a 3-D image, a depth profile map associated therewith may be utilised and the depth values can be derived from the depth profile map. Thus the computation of the preferred embodiment makes use of data which is already available or can easily be derived.

If the image is 2-D, the depth values may be derived from an estimated depth profile map of the 2-D image and the processing is the same as for a 3-D image.

In the event that a depth profile map is not estimated or would be difficult to compute for the 2-D image the first and second clusters may be taken from a plurality of different cues, such as, for example, motion and focus.

Therefore, in the preferred embodiment, given a depth profile, the fit of this profile can be compared to two different depth models: a smooth depth profile (e.g. linear depth variation with vertical image coordinate), and a profile consisting of two clusters (e.g. foreground and background depth). For a long shot, a smooth profile is expected to result in a better fit, whereas for a medium shot or close-up, a cluster profile is expected to result in a better fit.

### BRIEF DESCRIPTION OF THE DRAWINGS

For a more complete understanding of the present invention, reference is made to the following description taken in conjunction with the accompanying drawings, in which:

FIGS. 1a and 1b are examples of a long shot video frame and a medium shot video frame, respectively;

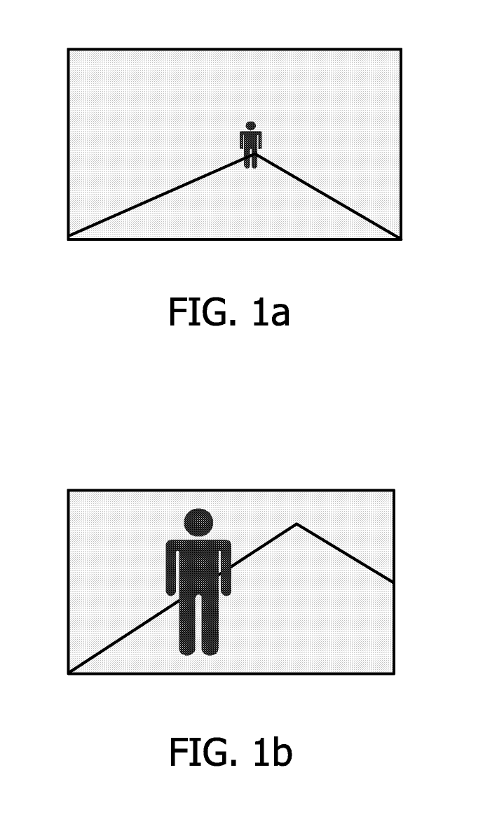

FIG. 2 illustrates a flow chart of the steps of the shot classification system according to a preferred embodiment of the present invention;

FIG. 3 illustrates a flow chart of the details of step 205 of FIG. 2; and

FIG. 4 illustrates a flow chart of the steps of the shot classification system according to a second preferred embodiment of the present invention.

### DETAILED DESCRIPTION OF THE PREFERRED EMBODIMENTS

Although the description refers to distinction of long shot types and close-ups, it can be understood that the embodiments are also equally applicable to classifying a medium shot by merely appropriate settings of the thresholds.

The method of the first preferred embodiment is applicable to classification of either a 2-D or 3-D image.

As normally in 2D video no depth profile is present, this can be computed from the video itself. For 2D-to-3D video conversion, depth cues are used which are computed from the image data. These techniques are well known in the art and will not be described in detail here. In the case of a 3-D video a depth profile may be present. For example if a 3D camera has been used, apart from a normal video stream, a direct depth stream is also recorded. Furthermore, stereo material may be available, from which depth information can be extracted.

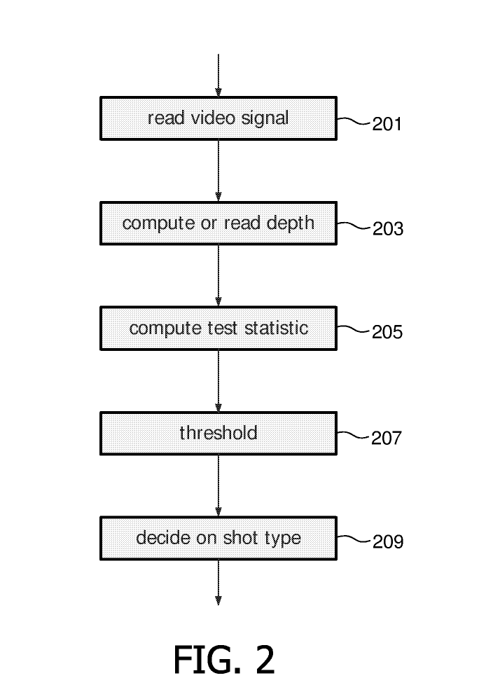

With reference to FIG. 2, the method according to a first preferred embodiment comprises the steps of: reading the input video signal, step 201; computing (in the case of a 2-D image or 3-D image in which the depth profile is not recorded) or reading (in the case of 3-D image having a recorded depth profile associated therewith) the depth profile, step 203, computing test statistic(s), step 205, and comparing these to relevant thresholds, step 207 and defining the shot type there from, step 209.

Apparatus according to a preferred embodiment of the present invention comprises interface means for the input of an image. The interface means is connected to a processor which is adapted to carry out the method steps of FIG. 2.

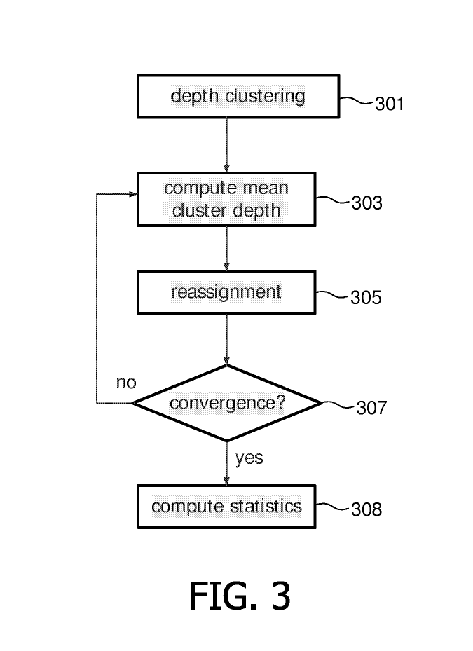

Details of step 205, compute test statistic, are shown in FIG. 3.

First the video frame is depth clustered, step 301. The pixels of the video frame are divided into two clusters of depth values, namely the foreground and background. The initial clustering consists of assigning image portions or blocks of pixels on the left, top and right border (say ¼ of the image) to the ‘background’ cluster, and the other pixels to the ‘foreground’ cluster. Then an iterative procedure, steps 303 to 307, is carried out to refine this cluster:

In step 303, for each of the two clusters, an average cluster depth is computed. Then in step 305, the image is swept, and for each portion on a cluster boundary, it is assigned to the cluster which has the smallest difference to the mean depth of the cluster. These steps are repeated until convergence occurs, step 307. It has been observed that this, typically, takes 4 iterations.

Having generated two clusters, the various statistics used to test the clusters are computed, step 308.

The statistics computed are, for example, the difference of their means, their standard deviations, and their areas.

In general, a small difference in mean, or a small area for one of the clusters indicates that there is no evidence for a cluster, i.e. the frame is a long shot whereas a small standard deviation (compared to the difference in means) indicates that the clustering is significant, i.e. a close-up shot.

The test statistic which is used to distinguish the shot types is given as:

$${t}_{m} = 4 \frac{Δ μ}{{σ}_{t}} {a}_{1} {a}_{2} , \qquad ( 1 )$$

where α₁ and α₂ are the fractions of the area of each cluster (such that α₁+α₂=1), is the difference between the cluster means, and is the standard deviation of the depth signal.

For the case that each cluster occupies half of the image, this expression is the conventional test to test whether a difference in mean is significant. Hence, for a 95% confidence interval,

tₘ>1.96 (2)

This would signify the existence of two different clusters; a close-up shot. As the fraction of foreground, and background depth is typically not exactly 50%, one may choose the threshold a bit smaller. Another approach would be an empirical determination of a threshold based on statistics of large amounts of video content, for instance based on a precision/recall curve.

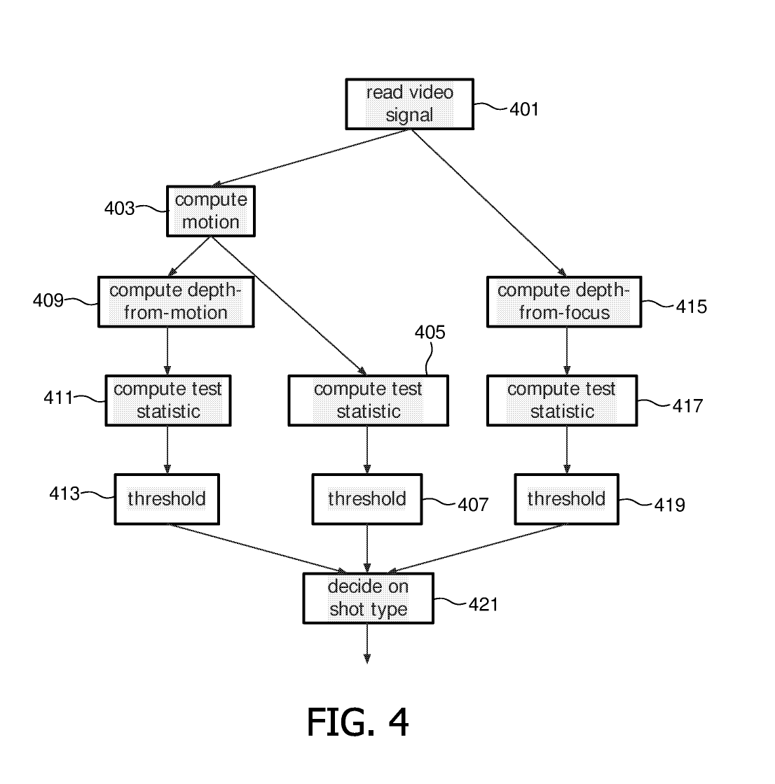

If the depth is computed from 2D videos, the above embodiment can be carried out directly. However, an alternative is described below with reference to FIG. 4.

In the current depth estimation process, the depth signals derived from the different cues are (linearly) merged. Hence, instead of using the combined depth profile, a limited subset of cues may be used. Depth cues may be physiological or psychological in nature. In this embodiment of the present invention only the depth signal derived from motion and focus analysis is used. Table 1 below distinguishes the different situations.

TABLE 1

| Motion present | Motion cluster | Focus cluster | Conclusion |
|---|---|---|---|
| yes | yes | yes | close-up or |
| | | | medium shot |
| yes | yes | no | close-up or |
| | | | medium shot |
| yes | no | yes | close-up or |
| | | | medium shot |
| yes | no | no | long shot |
| no | no | yes | close-up or |
| | | | medium shot |
| no | no | no | undecideable |

Basically, if a depth signal consisting of two clearly distinguishable clusters (in either of the depth cues) is obtained, this indicates a close-up; if there are no depth cue with distinct clustering, this indicates a long shot. However, in the case of a static scene (no camera or object movement), a distinction cannot be made.

With reference to FIG. 4, a second embodiment of the present invention will be described.

Firstly the incoming video signal is read, step 401. Next, the motion estimation is computed, step 403. This is carried out using a conventional 3DRS motion estimation, for example, as described in G de Haan and P. W. A. C. Biezen, “An efficient true-motion estimator using candidate vectors from a parametric motion model, IEEE Transactions on Circuits and Systems for Video Technology, vol. 8, p. 85-91, 1998. A less preferred alternative (since the motion field is less smooth) would be to use MPEG motion vectors.

In step 405, the motion detection test statistic is computed. To detect whether there is motion or not, the following test statistic is used:

$${t}_{c} = \frac{1}{{N}_{b}} {\sum }_{b } ‖ m ( b ) ‖ , \qquad ( 3 )$$

where b labels all blocks, N_{b} is the number of blocks and m(b) is the motion vector. Hence t_{c} is the average magnitude of the motion.

This is then compared to a motion detection threshold, step 407. If

t_{V}<1 pixel, (4)

the frame is classified as having no motion.

In step 409 the depth from motion is computed. To compute a depth signal from the motion field, the background motion is subtracted. Estimation of background motion consists of estimating a pan-zoom model (consisting of translation and zoom parameters). This is known in the art. Subsequently, the depth-from-motion signal dₘ is computed as:

dₘ(b)=∥m(b)−m_{bg}(b)∥ (5)

where m_{bg} is the predicted background motion vector in the specified block.

Next, in step 411, the depth-from-motion clustering, test statistic is computed and compared to a threshold in step 413 similar to the method described above and given by equations (1) and (2).

Further, in step 415, depth from focus is computed. Focus can be computed for instance using the method disclosed by J. H. Elder and S. W. Zucker, “Local scale control for edge detection and blur estimation”, IEEE Transactions on Pattern Analysis and Machine Intelligence”, vol. 20, p. 689-716, 1998.

Next, in step 417, the depth-from-focus clustering, test statistic is computed and compared to a threshold in step 419 similar to the method described above and given in equations (1) and (2).

According to table 1, a decision is taken as to the shot type, step 421. This can be done on an individual frame basis, or as a majority vote over all frames in a shot. In an alternative embodiment a probability to a certain shot type given the values of the test statistics may be assigned and from this the shot type is derived.

Although preferred embodiments of the present invention have been illustrated in the accompanying drawings and described in the foregoing detailed description, it will be understood that the invention is not limited to the embodiments disclosed but is capable of numerous modifications without departing from the scope of the invention set out in the following claims.

1. A method for determining the type of shot of an image, the method comprising the steps of:
assigning portions of the image to at least a first cluster or a second cluster, the clusters having different ranges of depth values associated therewith; and
determining the shot type of the image on the basis of whether both said first and second clusters have been assigned at least one portion or whether there is a stepped or gradual change in the difference between the depth values of said first and second clusters.

2. A method according to claim 1, wherein the decision whether there is a stepped or gradual change in the difference of depth values is based on statistical properties of said clusters.

3. A method according to claim 2, wherein the statistical properties include at least one of a difference in the means of said depth values between said first and second clusters, a standard deviation of depth values in a cluster and the area of a cluster.

4. A method according to claim 3, wherein the step of determining whether there is a stepped or gradual change in the difference between the depth of said first and second clusters comprises the steps of:
comparing the standard deviation of the depth values in one of said first and second clusters with the difference in the mean depth values between said first and second clusters; and
if the standard deviation is relatively small compared to the difference in the mean depth values, there is a stepped change in the difference between the depth of said first and second clusters and the image is classified as a short shot type.

5. A method according to claim 3, wherein the step of determining whether there is a gradual change in the difference between the depth of said first and second clusters comprises the steps of:
comparing the difference in the mean depth values between said first and second clusters;
determining if the difference between the mean depth values is less than a threshold value; and
if the difference between the mean depth values is less than the threshold value, there is a gradual change in the difference between the depth of said first and second clusters and it is determined that the image is a long shot.

6. A method according to claim 3, wherein the method further comprises the step of:
comparing the areas of each of said first and second clusters; and if one of said first and second clusters is small, or zero, or if the difference in area is greater than a threshold value, the image is determined as a long shot type.

7. A method according to claim 1, wherein said first and second clusters comprise the background and the foreground of said image.

8. A method according to claim 1, further comprising the steps of:
identifying said portions of said image which are on the border between said first and second clusters;
computing the difference of the depth of the pixels of said identified portion of said image with the mean depth value of each of said first and second clusters; and
assigning said portion to the cluster having the smallest depth difference.

9. A method according to claim 1, wherein said image is a 3-D image having a depth profile map associated therewith, the depth values being derived from the depth profile map.

10. A method according to claim 1, wherein said image is a 2-D image

11. A method according to claim 10, wherein the depth values are derived from an estimated depth profile map of said 2-D image.

12. A method according to 10, wherein said first and second clusters are taken from a plurality of different cues.

13. A method according to claim 12, wherein the cues include motion and focus.

14. Apparatus for determining the type of shot of an image, the apparatus comprising:
interface means for the input of an image; and
a processor for assigning portions of the image to at least a first cluster or a second cluster, the clusters having different ranges of depth values associated therewith and for determining the shot type of the image on the basis of whether both said first and second clusters have been assigned at least one portion or whether there is a stepped or gradual change in the difference between the depth values of said first and second clusters.

15. A computer program product comprising a plurality of program code portions for carrying out the method according to claim 1.
